(19) United States
(12) Patent Application Publication
(10) Pub. No.: US 2017/0233240 A1
(43) Pub. Date: Aug. 17, 2017

(54) METHODS AND APPARATUS FOR ORAL HYDRATION UNIT

(71) Applicant: Nektarios A. Bouzis, Gillette, WY (US)

(72) Inventor: Nektarios A. Bouzis, Gillette, WY (US)

(21) Appl. No.: 15/433,893

(22) Filed: Feb. 15, 2017

Related U.S. Application Data
(60) Provisional application No. 62/295,217, filed on Feb. 15, 2016.

(51) Int. Cl. B67D 3/00; A47G 9/00; A47G 9/10; A47C 21/00

(52) U.S. Cl. CPC B67D 3/0032; B67D 3/0061; B67D 3/0083; A47C 21/00; A47G 9/007; A47G 9/1045

(57) ABSTRACT

Apparatus and methods according to various aspects of the present technology may comprise a fluid reservoir configured to provide a user with access to the fluid while the user is in bed. In one embodiment, the fluid reservoir may comprise a body suitably configured to be positioned near the bed while allowing the user to receive fluid from the reservoir without having to sit up or get out of bed. In one embodiment, the fluid reservoir may comprise a flexible delivery conduit having a valve at one end that allows the user to ingest the fluid when desired.

### CROSS-REFERENCES TO RELATED APPLICATIONS

This application claims the benefit of U.S. Provisional Patent Application No. 62/295,217, filed Feb. 15, 2016, and incorporates the disclosure of the application by reference.

### BACKGROUND OF INVENTION

Xerostomia, commonly called dry mouth, is a condition experienced by many people. For example, dehydration, mouth breathing or snoring during sleep may exacerbate xerostomia. The sufferer may experience discomfort during sleep from resulting conditions such as angular cheilitis, burning mouth, dry tongue, and the tongue sticking to portions of the mouth. Disrupted homeostasis of the oral cavity may also, for example, increase susceptibility to oral infection and dental disease, negatively impacting both oral and systemic health.

Symptomatic management of dry mouth includes frequent ingestion of fluids, such as water, saliva substitutes, and saliva stimulants. Sufferers of dry mouth often are awoken due to the condition and find themselves in need of oral hydration. Common methods of providing oral hydration during the night require the sufferer to get out of bed or sit up to ingest water or some other fluid, disrupting sleep and creating added inconvenience for the sufferer.

### SUMMARY OF THE INVENTION

Apparatus and methods according to various aspects of the present technology may comprise a fluid reservoir configured to provide a user with access to the fluid while in bed. In one embodiment, the fluid reservoir may comprise a body suitably configured to be positioned near the bed while allowing the user to receive fluid from the reservoir without having to sit up or get out of bed. In one embodiment, the fluid reservoir may comprise a flexible delivery conduit having a valve at one end that allows the user to ingest the fluid when desired.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures.

FIG. 1 representatively illustrates a fluid reservoir in accordance with an exemplary embodiment of the present technology;

FIG. 2 representatively illustrates the fluid reservoir disposed within a pillow case in accordance with an exemplary embodiment of the present technology;

FIG. 3 representatively illustrates the fluid reservoir positioned within a storage container in accordance with an exemplary embodiment of the present technology;

FIG. 4 representatively illustrates the storage container in accordance with an exemplary embodiment of the present technology;

FIG. 5 representatively illustrates a cross-sectional view of the storage container showing insulated walls in accordance with an exemplary embodiment of the present technology;

FIG. 6 representatively illustrates the storage container attached to a bed in accordance with an exemplary embodiment of the present technology; and

FIG. 7 representatively illustrates the storage container attached to a side table in accordance with an exemplary embodiment of the present technology.

### DETAILED DESCRIPTION OF EXEMPLARY EMBODIMENTS

The present technology may be described in terms of functional block components and various processing steps. Such functional blocks may be realized by any number of components configured to perform the specified functions and achieve the various results. For example, the present technology may employ various materials, containers, conduits, valves, dimensions, and geometries, which may carry out a variety of operations suited to a specified condition, application, or environment. In addition, the present technology may be practiced in conjunction with any number of systems configured for operation with fluids and/or fluid delivery systems, and the system described is merely one exemplary application for the technology. Further, the present technology may employ any number of conventional techniques for fluid delivery, insulation, attachment, and the like.

Methods and apparatus for an oral hydration unit according to various aspects of the present technology may operate in conjunction with any fluid reservoir and/or conduit system such as that used to pipe fluids from a bladder to a delivery point, and the like. Various representative implementations of the present technology may be applied to any container and/or delivery system that may be used to easily deliver a specified amount of fluid to a user to help combat dry mouth.

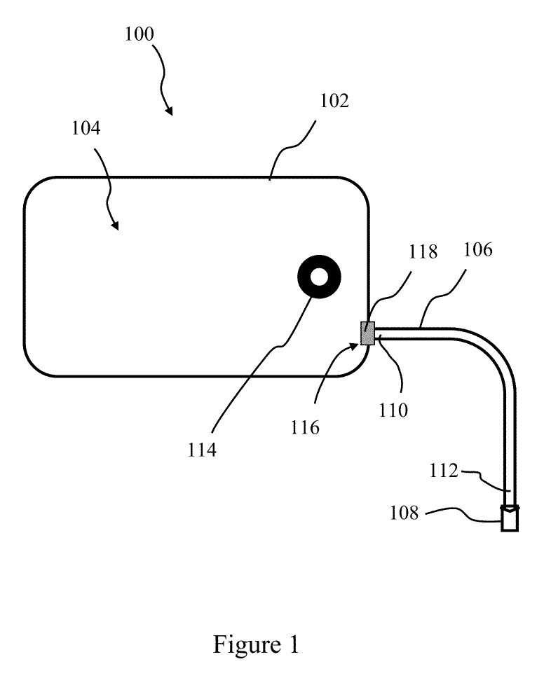

Referring now to FIG. 1, in one embodiment of the present technology, the oral hydrating device 100 may comprise a body 102, a delivery conduit 106, and a mouthpiece 108. The delivery conduit 106 may comprise a proximal portion 110 coupled to the body 102 and a distal portion 112 coupled to the mouthpiece 108. The oral hydrating device 100 may further comprise an attachment system for securing the oral hydrating device 100 to an external system or element such as a headboard, side table, post, wall, or the like.

The body 102 may be adapted store a desired amount of fluid and may comprise any suitable system or device for storing a liquid adapted to aid in oral cavity or oropharynx hydration. For example, the body 102 may comprise a fluid reservoir 104, such as an expandable pouch, a bladder, or the like. The fluid reservoir 104 may also comprise a fill port 114 such as a cap or valve. The fill port 114 may be sized to allow ice to be inserted into the fluid reservoir 104 to help cool the fluid. The fluid reservoir 104 may further comprise an exit port 116 configured to couple to the proximal portion 110 of the delivery conduit 106.

The body 102 may comprise any suitable size allowing it to store a desired amount of liquid. The body 102 may also comprise any suitable dimensions selectively chosen for positioning the body 102 adjacent to particular areas of an external system. In one embodiment, the body 102 may comprise a length of between approximately about fifteen centimeters to about twenty centimeters, a width of between about twenty-five centimeters to about thirty centimeters, and a thickness of about twelve centimeters. In a second embodiment, the body 102 may be sized to create a predetermined volume for the fluid reservoir 104 such as one liter.

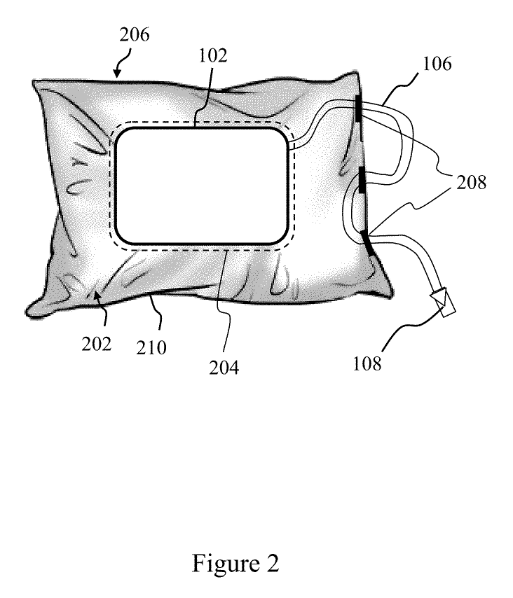

The body 102 may further comprise any suitable shape for allowing the body 102 to easily fit against, conform to, or otherwise contour to a particular external system. Referring now to FIG. 2, the body 102 may comprise substantially rectangular shape suitably configured to fit within a pillow 202 during use. For example, the pillow 202 may comprise a receiving area 204 suitably configured to receive the body 102 and hold it in position or otherwise prevent the body 102 from shifting around inside the pillow 202. In one embodiment, the receiving area 204 may comprise a shape conforming to the exterior dimensions of the body 102 when filled with fluid but with slightly larger dimensions such that the receiving area 204 forms a pocket for holding the body 102 in place.

The pillow 202 may comprise any suitable material such as a compressible foam, latex, or similar material such that an outer perimeter 206 of the pillow 202 will substantially retain its shape during use when the body 102 is positioned within the pillow 202. The receiving area 204 may be accessed by any suitable method or system. For example, the receiving area 204 may comprise an open recessed section formed along one side of the pillow 202 or the receiving area 204 may comprise an open interior cavity accessible from a side of the pillow 202.

The pillow 202 may further comprise a pillow case 210 having a plurality of openings 208 disposed along one or more sides of the pillow case 210 that are configured to allow the delivery conduit 106 to pass from inside the pillow case 210 to outside of the pillow case 210. Each opening 208 may be configured to limit movement of the delivery conduit 106 during use. For example, each opening 208 may comprise an elastic perimeter configured to tighten around the delivery conduit 106 to help secure it in place or prevent the mouthpiece 108 from receding into the pillow case 210 during use.

One opening 208 may also be used to help position the distal portion 112 of the delivery conduit 106 such that the mouthpiece 108 is more readily accessible to the user. For example, the delivery conduit 106 may be fed through one or more openings 108 of the pillow case 210 such that the final twenty to thirty centimeters of the delivery conduit 106 and the mouthpiece 108 extend out from the pillow case 210. This amount of tubing may be sufficient to allow the user to easily position, locate, and use the mouthpiece 108 while in bed or trying to sleep. By positioning the mouthpiece 108 in a more easily accessible location, the user may be more likely to take in a sufficient amount of fluid to reduce the likelihood of dry mouth or better maintain oral hydration.

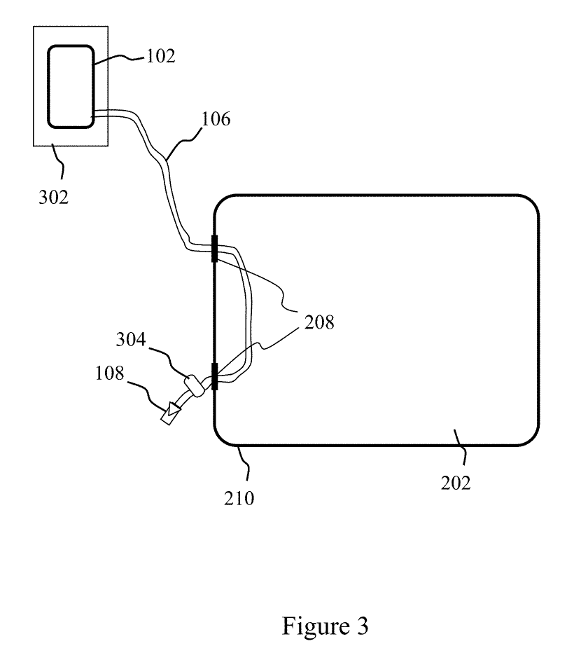

In an alternative embodiment, and referring now to FIG. 3, the body 102 may comprise a shape suitably configured to be positioned within a storage system 302 that may be placed near a user's bed headboard, nightstand, or other position near the user's location such that the delivery conduit 106 may run from the storage system 302 to the pillow 202 to allow the user easy access to the mouthpiece 108. Similar to the previous embodiment, the pillow case 210 may comprise one or more openings 208 that help position the delivery conduit 106 at a location accessible to the user.

The fluid reservoir 104 may comprise any suitable material suitable for storing a fluid that may be ingested by the user. For example, the fluid reservoir 104 may comprise a natural or synthetic material such as rubber, silk, polymers (poly(ethylene terephthalate) (PET), polyethene (PE), polypropylene (PP), nylon (NY), polytetrafluorothylene (PTFE), polyvinyl chloride (PVC), polyvinylidene fluoride (PVDF) and/or any combination thereof), and the like. The fluid reservoir 104 may be insulated to help maintain a desired temperature for the fluid. For example, in one embodiment, the fluid reservoir 104 may comprise a foam insulated rubber bladder suitably configured to fit inside of the pillow 202 and use the pressure from the user's head to help the fluid flow through the delivery conduit 106. Alternatively, the fluid reservoir 104 may comprise a bladder suitably configured to fit inside of the storage system 302 and use gravity as the mechanism to help move the fluid from the body 102 to the mouthpiece 108.

The delivery conduit 106 provides a path for the fluid to travel between the fluid reservoir 104 and the user. The delivery conduit 106 may comprise any suitable system or device for directing a fluid flow such as a flexible tube, hose, pipe, and the like. The delivery conduit 106 may also comprise any suitable natural or synthetic material. In some embodiments, the delivery conduit 106 may comprise the same material as the body 102.

The delivery conduit 106 may be coupled to the body 102 by any suitable method or device. In one embodiment, the delivery conduit 106 may be selectively coupled to the body 102 by a quick connect fitting 118. For example, the proximal portion 110 of the delivery conduit 106 may comprise a male fitting suitably adapted to be inserted into a matching female fitting disposed on the body 102. In a second embodiment, the body 102 may comprise more than one connector suitably configured to receive a delivery conduit 106 such that the delivery conduit 106 may be coupled to the body 102 at more than one position or more than one delivery conduit 106 may be used to allow the user to obtain fluid from more than one mouthpiece 108.

The delivery conduit 106 may comprise any suitable length and may be determined according to a particular installation or application. For example, referring again to FIG. 2, in one embodiment, the length of the delivery conduit 106 may comprise a length of between about thirty and about fifty centimeters such that the user can relatively easily access the delivery conduit 106 lying on the pillow 102 in a prone or supine position. Referring now to FIG. 3, in an alternative embodiment, the delivery conduit 106 may comprise a length of up to about one hundred centimeters such that the delivery conduit 106 may run from the storage container 302 to the pillow 202.

The distal portion 112 of the delivery conduit 106 may further comprise an attachment mechanism 304 configured to help position the mouthpiece 108 at a desired location. For example, the attachment mechanism 304 may comprise a clasp or clamp suitably configured to secure the mouthpiece 108 to a pillow, bed sheet, or other structure.

The mouthpiece 108 allows the user to access the fluid. The mouthpiece 108 may comprise any suitable system or device for controlling the flow of the fluid from the delivery conduit 106. For example, in one embodiment, the mouthpiece 108 may comprise a bite valve that is suitably configured to allow the fluid to flow when the user bites, squeezes, or otherwise compresses or exerts pressure on the mouthpiece 108. In an alternative embodiment, the mouthpiece 108 may comprise a pressurized valve responsive to a reduction of pressure on one side of the valve. For example, the mouthpiece 108 may be configured such that when the user sucks on an end of the mouthpiece 108 the resulting reduction in pressure may open the valve and allow the fluid to flow. In yet another embodiment, the mouthpiece 108 may comprise a manually activated valve such as a gate valve or ball valve that acts as an on and off switch for the flow of fluid.

The mouthpiece 108 may also be configured to convert the liquid into a mist when activated. For example, the mouthpiece 108 may comprise a pressurizing valve or nozzle system suitably configured to atomize the fluid. In addition, the mouthpiece 108 may be configured with a backflow-prevention device to prevent fluid from flowing back into the delivery conduit 106.

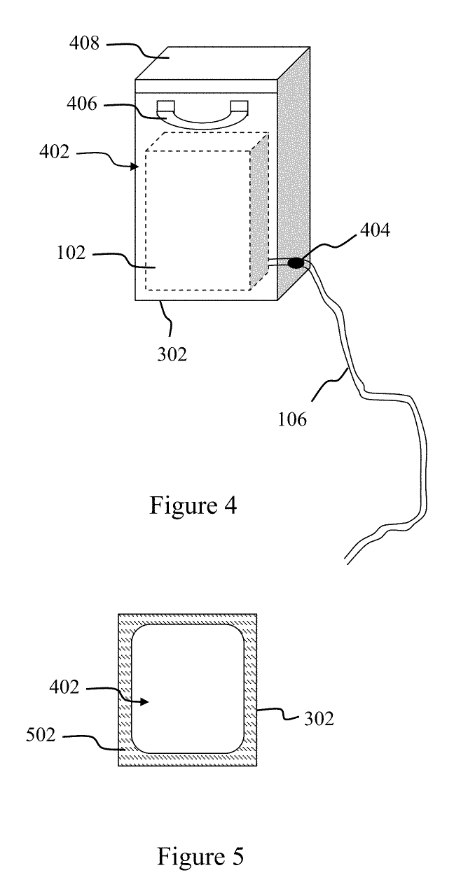

The storage container 302 houses the body 102 and may be configured to be securely positioned near the user. The storage container 302 may comprise any suitable system or device for storing the body 102 such as a box, bag, or insulated carrying case. Referring now to FIGS. 4 and 5, the storage container 302 may comprise an interior volume 402 configured to receive the body 102 and a pass through section 404 suitably configured to allow the delivery conduit 106 to exit the storage container 302. The storage container 302 may further comprise a handle 406 to help facilitate transport of the storage container 302.

The inner volume 402 of the storage container 302 may be accessed through any suitable method. For example, the storage container 302 may comprise a pivotable lid 408 configured to move between an open and a closed position. One or more walls of the storage container 402 may also comprise an insulating material 502 to help maintain a desired fluid temperature during use.

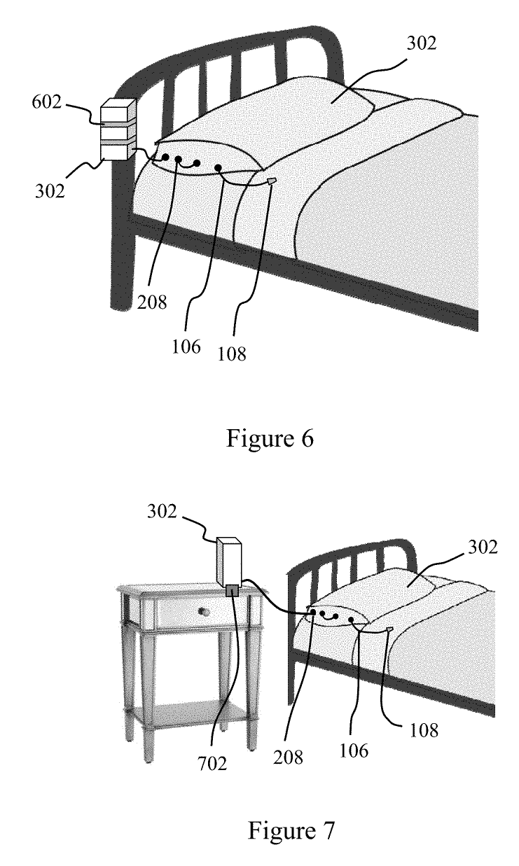

Referring now to FIG. 6, the storage container 302 may also comprise an attachment system configured to secure the storage system 302 in place during use. For example, the storage container 302 may comprise one or more straps 602 suitably configured to wrap around a bed post to securely position the storage container 302 to the user's bed. In an alternative embodiment and referring now to FIG. 7, the storage container 302 may comprise a clamp system 702 suitably configured to selectively attach the storage container 302 to a nightstand or bedside table. In a third embodiment, the handle 406 may be suitably configured to attach to a mating wall-mounted receptacle (not shown) to allow the storage container 302 to be hung on the wall near the user.

The particular implementations shown and described are illustrative of the technology and its best mode and are not intended to otherwise limit the scope of the present technology in any way. For the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the technology has been described with reference to specific exemplary embodiments. Various modifications and changes may be made, however, without departing from the scope of the present technology as set forth in the claims. The specification and figures are illustrative, rather than restrictive, and modifications are intended to be included within the scope of the present technology. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including”, “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

1. An oral hydration device, comprising:
a fluid reservoir;
a delivery conduit having a proximal end configured to be coupled to the fluid reservoir and a distal end;
a mouthpiece coupled to the distal end; and
an attachment mechanism coupled to the delivery conduit proximate the distal end, wherein the attachment mechanism is configured to selectively position and secure the distal end at a desired location.

2. The oral hydration device of claim 1, wherein the fluid reservoir comprises a bladder.

3. The oral hydration device of claim 1, wherein the fluid reservoir comprises:
a fill port; and
an exit port configured to be coupled to the proximal end of the delivery conduit.

4. The oral hydration device of claim 3, further comprising a quick connect fitting coupled between the exit port and the proximal end of the delivery conduit and configured to allow the proximal end of the delivery conduit to be selectively attached and detached from the exit port.

5. The oral hydration device of claim 1, further comprising a pillow having an internal receiving area configured to receive the fluid reservoir and secure it in position.

6. The oral hydration device of claim 5, further comprising a pillow case having a plurality of openings disposed along one or more sides of the pillow case, wherein each of the plurality of openings is configured to allow the delivery conduit to pass from inside the pillow case to the outside of the pillow case.

7. The oral hydration device of claim 6, wherein each of the plurality of openings comprises an elastic perimeter configured to tighten around the delivery conduit.

8. The oral hydration device of claim 1, wherein the mouthpiece comprises a bite valve.

9. The oral hydration device of claim 1, wherein the attachment mechanism comprises a clamp.

10. The oral hydration device of claim 1, further comprising:
a storage container configured to house the fluid reservoir within an internal volume; and
a second attachment mechanism configured to secure the storage container to an external structure.

11. The oral hydration device of claim 10, wherein the storage container comprises a pass through section configured to allow the delivery conduit to exit the internal volume of the storage container.
